(19) United States
(12) Patent Application Publication
(10) Pub. No.: US 2005/0232616 A1
(43) Pub. Date: Oct. 20, 2005

(54) Thermostat for water boiler

(76) Inventor: Yosef Magal, Kdumim (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/512,042

(22) PCT Filed: Aug. 25, 2003
(86) PCT No.: PCT/IL03/00700

§ 371 Date: Oct. 21, 2004

(30) Foreign Application Priority Data
Aug. 27, 2002 (IL) 151504

(51) Int. Cl. H05B 1/02

(52) U.S. Cl. 392/498

(57) ABSTRACT

A thermal control device (10) for electrically powered appliances, in particular a thermostat to protect against overheating of a hot water boiler. The thermostat having a structure (26) supporting a first (20) and second (18) electric switches disposed in series between an electric power supply and an electric heating element, an extended length first bimetal device (14) being arranged for thermal at least indirect contact with water being heated, a second bimetal device (16) disposed inside the first bimetal device and acting to open the second switch if the second bimetal device reaches a second temperature higher than a first temperature due to the failure of the first bimetal device to open the first switch.

### FIELD AND BACKGOUND OF THE INVENTION

The present invention relates to the thermal control of electrically powered appliances. More particularly, the invention provides a thermostat which improves security against overheating of a hot water boiler.

Thermostats are automatic control devices that switch electric power on/off with relation to the temperature of the material being controlled. These devices have been in widespread use for many decades in air conditioning, hot water boilers and in control of thermal industrial processes.

In hot water boilers when electric power applied is not properly controlled, the heater element can generate high or even dangerous steam pressure, aside from wasting much electricity and possibly burning out the element itself. Without a properly functioning thermostat, power could be connected for a long period to the heater element, and would not be switched off when water reaches a required temperature, for example about 60°-70° C. for residential use. A boiler fitted with a faulty thermostat either will not operate at all or will leave the current permanently connected.

One known type of thermostat failure occurs when the switch contacts become welded or stuck together, whereafter the thermostat is no longer responsive to high water temperature.

Unfortunately most hot water thermostats are located in a position where check-up for proper functioning is most unlikely to be carried out—such locations including roofs and storage lofts. Modern boilers are well protected against explosion, but thermostat failure which does occur can have unpleasant consequences, for example causing a failure to provide hot water needed when needed, and more seriously causing a person showering to be scalded by 90° C. water, or less seriously failing to heat water required for washing, showering or bathing.

In order to protect the boiler in case of thermostat failure, the thermostat is further equipped with a heat limitation arrangement.

The state of the art can be assessed from the following review of recent U.S. Patents. These patents also reference large numbers of older patents..

In U.S. Pat. No. 4,641,011 Roberts discloses a hot water container of a beverage making device. A running thermostat controls water temperature. A manually resettable safety thermostat is held against the container side for detecting high temperatures.

The dual control thermostat circuit disclosed by Robinson in U.S. Pat. No. 4,740,673 relates to an electrical circuit arranged to control both a hot water tank and a heat pump.

Friedman in U.S. Pat. No. 4,975,562 discloses an aquarium water heater controlled by a bimetal thermostat. Temperature is adjusted by rotating a cam which acts on a curved portion of the bimetal to change contact spacing. An indicator is included.

Bill proposes a method of holding a tool in contact with a thermostat adjustment screw in U.S. Pat. No. 5,101,471.

Moore et al. in U.S. Pat. No. 5,220,638 relate to a thermostat arranged for use in a fiberglass hot water tank.

The thermostat disclosed by Surgarek in U.S. Pat. No. 5,984,197 is a specialty device for controlling a thermal conducting medium in a cooling system by means of a thermally-activated valve.

A high temperature lockout and thermostat is disclosed by Goodwin et al. in U.S. Pat. No. 6,072,680. A resettable fuse device, a bimetallic switch and a contact control are wired in series. The resettable fuse device is preferably a positive temperature coefficient element whose temperature is responsive to an electric current passing therethrough.

There is only one bimetal device and the invention is addressed at temperature control of remote electronic equipment.

Detecting a malfunction in an internal combustion engine cooling system is the subject of U.S. Pat. No. 6,386,022 to Oka et al. Both a permanently closed and a permanently open thermostat are detected by comparing temperatures at different points in the cooling system.

Danko discloses an electric heater assembly with an in-line thermostat in U.S. Pat. No. 6,433,318 B2. Each flat blade of the thermostat is crimped to a circuit connection at one end and a screw connection to a flat blade at the other end,

### OBJECTS OF THE INVENTION

Bearing in mind this state of the art, it is one of the objects of the present invention to provide a thermostat with an improved heat limitation arrangement primarily intended to prevent overheating in hot water tanks even following failure of the prior-art bimetal thermostat commonly used at present.

It is a further object of the present invention to require manual intervention before reconnection of electric power following failure of the primary thermostat, thus drawing attention to needed servicing.

It is yet a further object of the present invention to provide a heat limitation arrangement being part of the thermostat and adopted to measure the heat of the water within the boiler.

### SUMMARY OF THE INVENTION

The present invention achieves the above objects by providing an improved thermostat and heat limitation arrangement for control of power to an electric hot water boiler, comprising a structure supporting a first and a second electric switch arranged to be interposed in series between a power supply and an electric heating element, an extended length first bimetal device being arranged for thermal at least indirect contact with water being heated and being supported by said structure, said extended length bimetal device comprising of a first pair of components made of materials being greatly different in the coefficient of linear thermal expansion, at least one of said components being tubular and the remaining component projecting into said structure to open said first switch when said first bimetal device reaches a first desired temperature, the improvement comprising the addition inside said first bimetal device of a second bimetal device comprising of a second pair of components made of materials being moderately different in their coefficient of linear thermal expansion, one of said second components also projecting into said structure to open said second switch if said second bimetal device reaches a second temperature higher than said first desired temperature due to failure of said first bimetal device to open said first electric switch.

The two components comprising each bimetal element referred to in the present specification are firmly joined together at their distal ends. Such joining is preferably effected by brazing, but other methods such as welding or crimping can be used, provided the joint is strong, rigid, durable and able to withstand a peak temperature of about 110° C.

In a preferred embodiment of the present invention there is provided a thermostat wherein said second switch when opened remains in the open state until a reset control is manually operated.

In a most preferred embodiment of the present invention there is provided a thermostat wherein said second bimetal device comprises a first material being a stainless steel and a second of said materials being invar steel.

It will thus be realized that the novel device of the present invention serves to ensure that the need for repair or replacement of a faulty thermostat is brought to the attention of the user by inhibiting further heating of the boiler pending manual intervention required to reset the second switch. The second switch is independent of the first switch and will be opened in the event of overheating even if the first switch is welded closed. Under normal operation the second switch will remain closed, because of the moderate expansion differential between the two metals—typically stainless steel and Invar steel—comprising its operating mechanism. Normal temperature control is achieved by the action of the first switch only, which is responsive to the mechanical movement generated by the large expansion differential between two metals—typically brass and invar steel—the source of the switch operating force.

Both of the switches in the thermostat of the present invention jump without dither between the on and off state, when mechanically actuated by the thermal expansion/contraction of one of the bimetal components. Mechanisms are in widespread use which achieve fast and decisive switching, and so to prevent sparking and early failure of the contact points. As no novelty is claimed for any such mechanism, the following specification does not detail the mechanical method used to utilize movement of the bimetal devices to operate either of the two switches.

Temperature adjustment set screws are provided for both bimetal elements Again, as no novelty is claimed in this regard, no description thereof is provided.

At least one of the switches shown in FIGS. 1 and 3 are two-pole switch which has some safety advantages, but It is of course feasible, and less costly, to effect the same result using single pole switches.

While the current text refers primarily to hot water boilers, it will be understood that the thermostat can be applied to further heat-control tasks also in industrial applications as well as temperature control of fluids other than water.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is an electric diagram of a preferred embodiment of the thermostat according to the invention, showing normal operation thereof following the water being heated having reached a desired temperature;

FIG. 2 is a schematic view of the thermostat showing the two pairs of bimetal components, the diameter of the tubing component being exaggerated for illustrative purposes;

FIG. 3 is an electric diagram of the same embodiment of the thermostat, showing abnormal operation thereof due to welded closed contacts and after the water has been heated above the desired temperature;

FIG. 4 is a plan view of an embodiment of the thermostat head wherein the first switch is of the single-pole type and the thermostat outer cover has been removed; and

FIG. 5 is a view of a perspective view of the thermostat with its outer cover in place.

### FULL DESCRIPTION OF THE INVENTION

There is seen in FIG. 1 an electrical diagram representing the improved thermostat 10 for control of power to the heating element 12 of an electric hot water boiler, the diagram showing the improvement of the invention, comprising the addition to the extended length first bimetal device 14 of a second bimetal device 16, and the addition of a second switch 18 to the first switch 20.

The first bimetal device 14 is arranged for thermal at least indirect contact with water being heated. The device 14 could be directly immersed in the water being heated, but current practice is to insert the bimetal device into a steel tube (not shown) which is immersed in the water. This arrangement eases servicing of the thermostat at the cost of some loss in accuracy.

To complete the diagram there is also shown in the figure the standard manually-operated user control switch 15.

With reference to the rest of the figures, similar reference numerals have been used to identify similar parts.

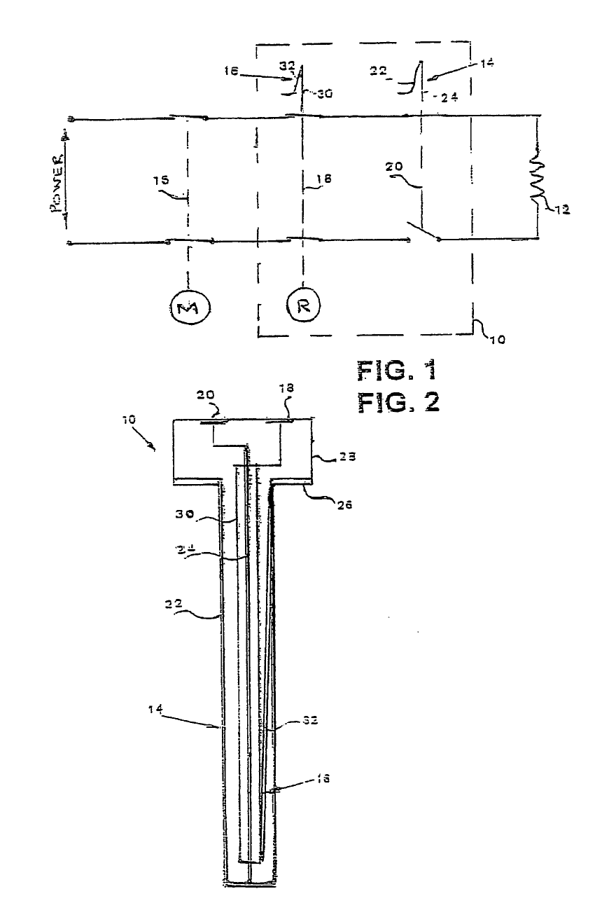

Referring now also to FIG. 2, there are seen both extended length bimetal devices. The first device 14, as in prior art, comprises a first pair of components 22, 24 made of materials being greatly different in the coefficient of linear thermal expansion. Preferred metals are brass for the outer tube 22, having a coefficient of linear thermal expansion of about 0.019 mm per meter per degree Centigrade, and an invar steel central rod 24 having a coefficient of less than 0.001.

The outer tube 22 at its proximate end is firmly joined to the metal plate 26. The central rod 24 is firmly joined at its distal end only to the outer tube 22. The proximate end of the rod 24 projects into the structure 28 to open the first switch 20 when the first bimetal device 14 reaches a first desired temperature, for example 60°-80° C.

The second pair of components 30, 32 is made of materials being moderately different in their coefficient of linear thermal expansion. The second bimetal device 16 is attached inside the first bimetal device 14

Regarding the second pair of components 30, 32, preferred metals are stainless steel for the first of the components 30 having a coefficient of linear thermal expansion of about 0.011 mm per meter per degree Centigrade, and an invar steel central rod having a coefficient of less than 0.001.

One of the second bimetal components 30 also projects into the structure 28 at a proximate end to open the second switch 18 if the second bimetal device 16 reaches a second temperature higher than the first desired temperature due to failure of the first bimetal device 14 to open the first electric switch 20.

At their distal end the pair of second bimetal components 30, 32 are mechanically joined. The component 32 not projecting into the structure 28 is firmly attached near the proximate end inside the outer tube 22.

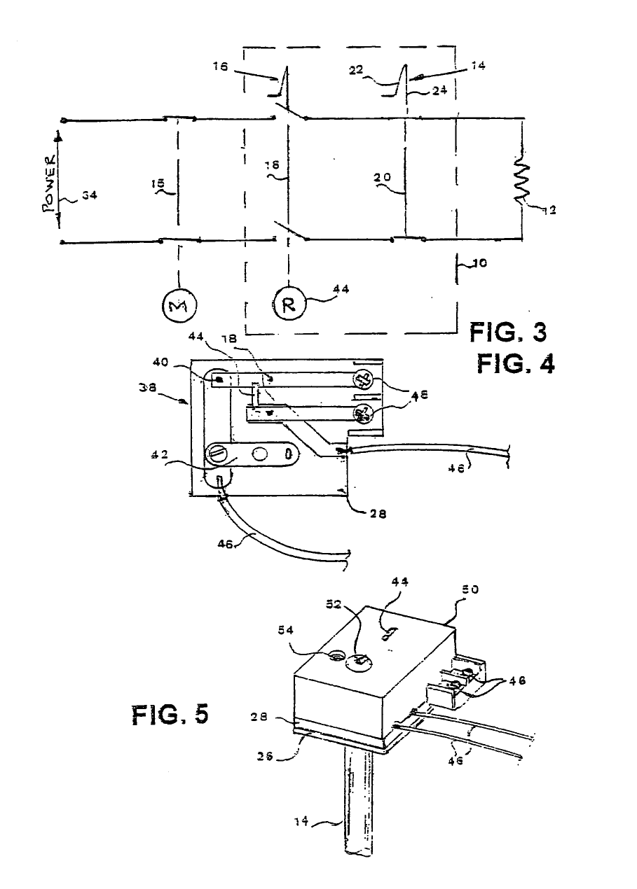

Illustrated in FIG. 3 is the state of the switches 18, 20 following failure of the first switch 20 to open due to a thermostat fault, for example the welding together of the contacts of the first switch 20.

Although the first switch 20 remains closed, the second switch 18 has been opened by the second bimetal device 16 and so has cut off electric power 34 from the boiler heating element 12.

Referring now to FIG. 4, there is seen in non-detailed form the insulating structure of a thermostat embodiment 38 with the cover removed.

An insulating structure 28 supports a first 40 and a second 18 electric switch arranged to be interposed in series between a power supply 34 and an electric heating element 12

In the present embodiment the first switch 40 is of the single-pole type. The bridge 42 seen thereabove is part of the switch operating/adjusting mechanism.

Advantageously the second switch 18, here of the two-pole type, when opened remains in the open state until a reset element 44 is manually operated. Power can be restored by pushing in the reset element 44. The need for doing so will remind the user that there is a problem needing attention, i.e. to repair or replace the thermostat.

The short wires 46 seen connect the thermostat 38 to the heater element 12. The screw terminals 46 are used to connect to the power supply.

FIG. 5 illustrates the thermostat 38 with its cover 50 in place. Apertures in the cover relate to adjustment 52 of the first bimetal device, adjustment 54 of the second bimetal device, and the reset element 44.

The first bimetal device 14 is supported over the insulating structure 28 by a metal plate 26 typically made of 2 mm thick steel.

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims. For example, the second bimetal device could be made of the same materials as the first bimetal device, but made of a much shorter length.

1. An improved thermostat and heat limitation arrangement for control of power to an electric hot water boiler, comprising a structure supporting a first and a second electric switch arranged to be interposed in series between a power supply and an electric heating element, an extended length first bimetal device being arranged for thermal at least indirect contact with water being heated and being supported by said structure, said extended length bimetal device comprising of a first pair of components made of materials being greatly different in the coefficient of linear thermal expansion, at least one of said components being tubular and the remaining component projecting into said structure to open said first switch when said first bimetal device reaches a first desired temperature, the improvement comprising the addition inside said first bimetal device of a second bimetal device comprising of a second pair of components made of materials being moderately different in their coefficient of linear thermal expansion, one of said second components also projecting into said structure to open said second switch if said second bimetal device reaches a second temperature higher than said first desired temperature due to failure of said first bimetal device to open said first electric switch.

2. The thermostat as claimed in claim 1, wherein said second switch when opened remains in the open state until a reset control is manually operated.

3. The thermostat as claimed in claim 1, wherein said extended length first bimetal device is composed of a brass outer tube and an invar central rod.

4. The thermostat as claimed in claim 1, wherein said second bimetal device comprises a first of said materials being a stainless steel and a second of said materials being invar steel.
